(19) United States
(12) Patent Application Publication
(10) Pub. No.: US 2003/0062068 A1
(43) Pub. Date: Apr. 3, 2003

(54) Method of and system for cleaning a semiconductor wafer simultaneously using electrolytically ionized water and diluted hydrofluoric acid

(76) Inventors: Hyung-Ho Ko, Seoul (KR); Kun-Tack Lee, Suwon-City (KR); Im-Soo Park, Seoul (KR); Yong-Pil Han, Seoul (KR); Song-Rok Ha, Seoul (KR)

Correspondence Address: VOLENTINE FRANCOS, P.L.L.C., 12200 Sunrise Valley Drive, Suite 150, Reston, VA, 20191, US

(21) Appl. No.: 10/135,452

(22) Filed: May 1, 2002

(30) Foreign Application Priority Data
Jul. 10, 2001 (KR) 2001-41229

(51) Int. Cl. B08B 3/10

(52) U.S. Cl. 134/28; 134/36; 134/100.1; 134/902

(57) ABSTRACT

The surface of a semiconductor wafer is cleaned simultaneously using diluted hydrofluoric acid and electrolytic ionized water. The electrolytic ionized water is produced using an electrolyte supplied into an intermediate cell of a 3-cell electrolyzer. The 3-cell electrolyzer has an anode cell, the intermediate cell, and a cathode cell partitioned from one another by ion exchange membranes. After deionized water is supplied into the anode cell and the cathode cell and the intermediate cell is filled with an electrolytic aqueous solution, electrolysis is carried out to produce electrolytic ionized water. The electrolytic ionized water and the hydrofluoric acid solution are then supplied to one or more semiconductor wafer cleaning apparatus. The simultaneous use of the electrolytic ionized water and the diluted hydrofluoric acid offers an improvement in removing contaminants from the surface of the wafer without damaging an insulating layer or a metal layer exposed at the surface of the semiconductor wafer.

### BACKGROUND OF THE INVENTION

1. Field of the Invention

The present invention relates to a method of cleaning semiconductor wafers. More specifically, the present invention relates to cleaning the polished surface of a semiconductor wafer using a hydrofluoric acid (HF) solution.

2. Description of the Related Art

Semiconductor wafers are cleaned several times during the course of manufacturing semiconductor devices from the wafers. To produce a flawless device, though, contaminants remaining on the semiconductor wafer must be completely removed by a cleaning process and a variety of layers on a substrate must be prevented from being damaged by the cleaning solution employed in the cleaning process.

For example, impurities must be removed from a semiconductor wafer after the wafer is polished by a chemical mechanical polishing (CMP) process. At the same time, the layers on the substrate must not be damaged. In a specific example, when CMP is used to form a damascene interconnect layer, especially one made of copper, impurities from the slurry used in the CMP process and impurities generated from the Cu damascene layer itself remain on the polished layer. The impurities from the slurry include Al₂O₃ abrasive and ionic impurities such as Fe, K, and Ca found in the CMP slurry. On the other hand, copper and copper oxide (CuOₓ) particles separated from the Cu damascene interconnect layer by the polishing process remain on the surface of the polished layer. All of these impurities must be removed. In addition, the Cu damascene interconnect, a barrier metal layer, and a low-k interlayer dielectric layer, such as a fluorosilicate glass layer in which the Cu damascene interconnect is embedded, should be protected during the cleaning process.

Dilute hydrofluoric acid solution is widely used in cleaning a semiconductor wafer following CMP used to form a Cu damascene interconnect. Although the dilute hydrofluoric acid solution can dissolve and remove the Al₂O₃ abrasive and CuOₓ particles, it cannot fully remove the Cu ions. Also, as shown in FIG. 1, the dilute hydrofluoric acid solution tends to etch a low-k interlayer dielectric layer 2, in which a Cu damascene interconnect 3 is embedded, by 200 Å or greater (d). As a result, concavities are formed in the surface of the interlayer dielectric layer 2. In addition, the dilute hydrofluoric acid solution degrades the properties of the low-k interlayer dielectric layer 2, thereby increasing the dielectric constant of the interlayer dielectric layer 2. Note, in FIG. 1, reference numeral 1 denotes a substrate.

Although these problems are prevalent in the above-described cleaning process following CMP used to form a Cu layer interconnect, the same problems occur in other processes where a low-k interlayer dielectric layer is exposed to dilute hydrofluoric acid cleaning solution.

### SUMMARY OF THE INVENTION

Therefore, one object of the present invention is to provide a semiconductor wafer cleaning method that will not damage any of the layers exposed to the cleaning solution, such as a low-k interlayer dielectric layer and/or a metal layer, while at the same time possessing a superior cleaning capability.

Another object of the present invention is to provide a cleaning method that is particularly well-suited for removing all of the impurities left on a semiconductor wafer as the result of chemical mechanical polishing and which will not damage any of the layers left exposed by the CMP process.

Still another object of the present invention is to provide a cleaning system that can be used to clean semiconductor wafers effectively cleaned and without being damaged.

To achieve these objects, the present invention provides a method of and a system for cleaning a semiconductor wafer simultaneously with electrolytic ionized water and a solution of diluted hydrofluoric acid (HF). The hydrofluoric acid solution preferably contains 0.06-0.7% by weight hydrofluoric acid. The ionized water is produced in an ionizing cell of an electrolyzer, preferably a 3-cell electrolyzer.

The 3-cell electrolyzer includes an anode (ionizing) cell, an intermediate cell and a cathode (ionizing) cell which are partitioned from one another by ion exchange membranes. Deionized water is supplied into the anode cell and the cathode cell, and the intermediate cell is filled with an electrolytic aqueous solution to produce the electrolytic ionized water through electrolysis.

The electrolytic aqueous solution may be an aqueous solution of 1-15% by weight ammonium hydroxide and 1-15% by weight fluoride. In this case, the fluoride may be hydrogen fluoride or ammonium fluoride. Preferably, the electrolytic ionized water comprises anode water containing oxidative substances with a pH of 6 or less, preferably a pH of 2˜6, and an oxidation-reduction potential (ORP) of +300 mV or greater, preferably +300˜+1000 mV.

Alternatively, the electrolytic ionized water may be an aqueous solution of 3-15% by weight ammonium hydroxide. In this case, the electrolytic ionized water may comprise anode water containing oxidative substances with a pH of 7-9 and an oxidation-reduction potential (ORP) of +100 mV or greater, preferably +100˜+600 mV.

Still further, the electrolytic aqueous solution is an aqueous solution of 3-5% by weight hydrochloric acid. In this case, the electrolytic ionized water may comprise anode water containing oxidative substances with a pH of 4 or less, preferably a pH of 2˜4, and an oxidation-reduction potential (ORP) of +700 mV or greater, preferably +700˜+1000 mV.

Preferably, the semiconductor cleaning method according to the present invention is applied to a semiconductor substrate having an exposed low-k dielectric layer whose dielectric constant is smaller than that of silicon dioxide thereon. Examples of such low-k dielectrics include hydrogen silsequioxane, fluorosilicate glass, polyimide, benzocyclobutene (BCB), Silk (Silicon insulator Low-k), hybrid organic siloxane polymer, and xerogel.

In one embodiment of the present invention, the electrolytic ionized water and the hydrofluoric acid solution are simultaneously supplied onto the surface of the semiconductor wafer during an initial stage of the cleaning process, and then only the electrolytic ionized water is supplied during a final stage of the cleaning process.

In another embodiment, the anode water and the hydrofluoric acid solution are simultaneously supplied onto the surface of the semiconductor wafer during an initial stage of the cleaning process, and then the anode water and cathode water are sequentially supplied onto the surface of the semiconductor wafer during a final stage of the cleaning process.

### BRIEF DESCRIPTION OF THE DRAWINGS

The above and other objects, features and advantages of the present invention will become more apparent by referring to the following detailed description of the preferred embodiments of the invention made with reference to the attached drawings, of which:

FIG. 1 is a sectional view of a semiconductor wafer after chemical mechanical polishing (CMP) is performed to form a copper damascene interconnect and then cleaned with diluted hydrofluoric acid (HF) solution;

FIG. 2A is a schematic diagram of a cleaning system including an electrolyzer for producing electrolytic ionized water according to the present invention;

FIG. 2B is a schematic diagram of another embodiment of the cleaning system for producing electrolytic ionized water according to the present invention;

FIG. 3 is a sectional view of a semiconductor wafer that has been cleaned according to the present invention after a CMP process has been performed to form a copper damascene interconnect;

FIG. 4 is a graph showing the number of slurry particles remaining on wafers that have been cleaned using both dilute HF solution and anode water produced by the cleaning system of FIG. 2A, using only anode water, using only cathode water, and using only diluted HF solution, respectively; and

FIG. 5A is a plan view of showing the points on a wafer at which the amount of Cu remaining on wafers are measured to produce the graph of FIG. 5B; and

FIG. 5B is a graph showing the amount of Cu on a wafer before it is cleaned, and after such wafers have been cleaned using both dilute HF solution and anode water produced by the cleaning system of FIG. 2A, using only anode water, using only cathode water, and using only diluted HF solution, respectively.

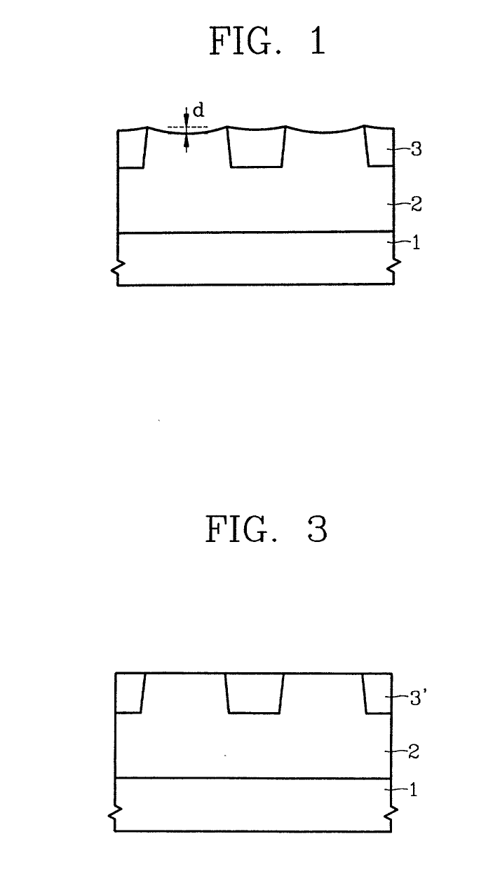

### DETAILED DESCRIPTION OF THE PREFERRED EMBODIMENTS

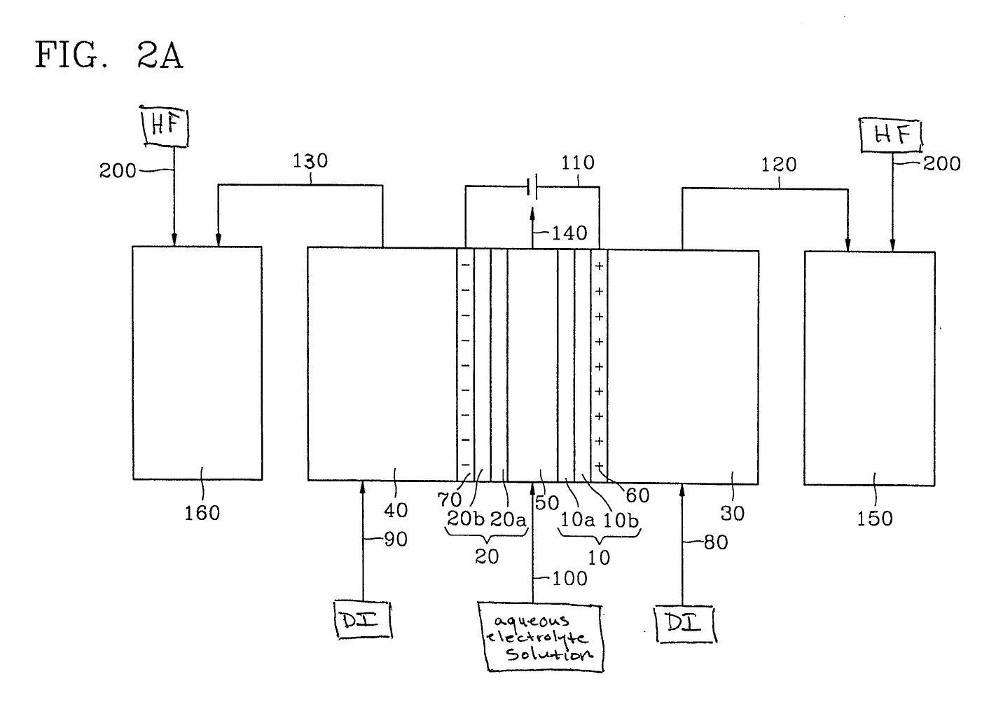

The present invention will now be described more fully with reference to the accompanying drawings. In the drawings, electrolyzers and cleaning apparatuses are illustrated schematically for the sake of convenience and ease of understanding, and the same reference numerals are used to designate like elements throughout the drawings. In addition, the term “cleaning-target object” used in the specification refers to any type of wafer used in the manufacture of semiconductor devices. Still further, the terms “electrolytic ionized water” used throughout the specification refer to cathode water and/or anode water produced by electrolyzers. These elecrolyzers will first be described below with reference to FIGS. 2A and 2B.

Referring now to FIG. 2A, an electrolyzer for use in the present invention is divided into an anode cell 30, a cathode cell 40, and an intermediate cell 50 by ion exchangers 10 and 20. The ion exchanger 10 that partitions the anode cell 30 from the intermediate cell 50 comprises an anionic exchange membrane 10a and a fluorine-based cationic exchange membrane 10b. The ion exchanger 20 that partitions the cathode cell 40 from the intermediate cell 50 comprises a cationic exchange membrane 20a and an anionic exchange membrane 20b. These configurations of the ion exchangers 10 and 20 are beneficial in producing anode water and cathode water having desired properties in terms of their pH and oxygen-reduction potential (ORP), for example.

Preferably, the fluorine-based cationic exchange membrane 10b has a uniform series of perforations that allow the anions dissociated in the intermediate cell 50 to fully migrate into the anode cell 30. Similarly, the anionic exchange membrane 20b preferably has a uniform series of perforations that allow cations dissociated in the intermediate cell 50 to fully migrate into the cathode cell 40.

An anode 60 is disposed in the anode cell 30 in contact with the ion exchanger 10 and, in particular, with the fluorine-based cationic exchange membrane 10b. On the other hand, a cathode 70 is disposed in the cathode cell 40 in contact with the ion exchanger 20 and, in particular, with the anionic exchange membrane 20b.

Deionized water from a DI water source is supplied into the anode cell 30 and the cathode cell 40 through first and second inlet lines 80 and 90, respectively, at a predetermined flow rate. An electrolytic aqueous solution having a predetermined concentration is supplied from a source thereof into the intermediate cell 50 through a third inlet line 100 until the intermediate cell 50 is filled up. A DC power source 110 causes current to flow from the anode 60 to the cathode 70, whereby electrolysis of the electrolytic aqueous solution begins in the intermediate cell 50. The flow rate of the deionized water and the magnitude of the electrolysis current vary depending on the capacity of the electrolyzer.

Anode water containing oxidative substances is produced in the anode cell 30 by electrolysis and then transferred through a first outlet line 120 into a first cleaning apparatus 150 for use in a cleaning process. At the same time, cathode water containing reductive substances is produced in the cathode cell 40 by electrolysis and then transferred through a second outlet line 130 into a second cleaning apparatus 160 for use in a cleaning process. Reference numeral 140 denotes an outlet line, i.e., a drain, for the electrolytic aqueous solution remaining in the intermediate cell 50.

The first and second cleaning apparatuses 150 and 160 may be any one of a variety of cleaning apparatus, known per se. These cleaning apparatuses include a simple spin apparatus, a sonic spin apparatus, a steam jet apparatus, a spray apparatus, a simple dipping apparatus, a batch-type megasonic dipping apparatus, a single-wafer type of megasonic dipping apparatus, and a single-wafer type of megasonic spin apparatus.

Diluted hydrofluoric acid (HF) is used for cleaning the wafers along with anode water or cathode water. To this end, a respective HF inlet line 200 connects a source of the HF solution to each of the first and second cleaning apparatus 150 and 160 for introducing diluted hydrofluoric acid (HF) into the cleaning apparatuses. And, although the outline lines 120 and 130 may be separate from the HF inlet lines 200 as shown, the first outlet line 120 and the HF inlet line 200 or the second outlet line 130 and the HF inlet line 200 may be merged into a single line near the first or second cleaning apparatus 150 or 160, respectively.

Furthermore, in the cleaning system of FIG. 2A, the cathode water and anode water are supplied into discrete first and second cleaning apparatuses 150 and 160, respectively. Alternatively, as shown in the cleaning system of FIG. 2B, the first and second outlet lines 120 and 130 may be connected to a common cleaning apparatus 170. In this system, cathode water and anode water are sequentially supplied into the cleaning apparatus 170. In this case, as well, an HF inlet line 200 is connected to the cleaning apparatus 170.

Preferred embodiments of the cleaning method according to the present invention will now be described in detail with respect to particular electrolytes that may be supplied into the intermediate cell 50. In a first embodiment of the cleaning method according to the present invention, deionized water is supplied into the anode cell 30 and the cathode cell 40 at a predetermined flow rate of, preferably, 1 L/min. The intermediate cell 50 is filled with an aqueous solution containing 1-15% by weight ammonium hydroxide and 1-15% by weight fluoride. Then, DC power from a DC power source 110 is applied to produce a predetermined electrolysis current of, preferably, 10A, flowing between the anode 60 and the cathode 70. As a result, electrolysis occurs.

During the electrolysis, the anode 60 of the anode cell 30 acts as an electron acceptor for deionized water supplied into the anode cell 30, and the cathode 70 of the cathode cell 40 acts as an electron donor for deionized water supplied into the cathode cell 40. The electrolyte supplied into the intermediate cell 50 is dissociated into anions (F⁻, OH⁻) and cations (H⁺, NH₄⁺), and the anions migrate into the anode cell 30, and the cations migrate into the cathode cell 40. The reactions in the cells 30 and 40 can be expressed as follows.

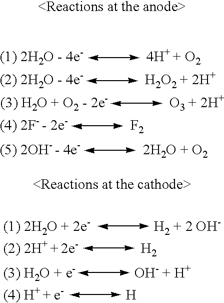

As is clear from the reaction schemes illustrated above, major components of the anode water produced in the anode cell 30 include oxidative substances, such as H⁺, O₂, O₃, and F₂, whereas major components of the cathode water produced in the cathode cell 40 include reductive substances, such as OH⁻, H^{.}, H₂, and NH₄⁺. The anode water containing such oxidative substances has a pH of 6 or less, preferably a pH of 2˜6, and an ORP of +300 mV or greater, preferably +300˜+1000 mV. The cathode water containing such reductive substances has a pH of 8 or greater and an ORP of −400 mV or less.

In the first embodiment of the cleaning method according to the present invention, a cleaning-target object is loaded into the first cleaning apparatus 150. Next, the anode water and diluted HF solution are supplied at the same time into the first cleaning apparatus 150 through the first outlet line 120 and the HF inlet line 200, respectively.

The cleaning-target object is preferably a wafer having a low-k dielectric layer on its surface, i.e., a dielectric constant smaller than that of silicon dioxide. Typical examples of such low-k dielectrics include organic substances such as fluorosilicate glass (FOₓ, k=3.5-3.8) with Si-F bonds that substitute for Si-O bonds, hydrogen silsequioxane (HSQ, k=2.8-3.0) with Si-H bonds that substitute for Si-O bonds, polyimide, benzocyclobutene (BCB), Silk (Silicon insulator Low-k), and hybrid organic siloxane polymer, and porous materials such as xerogel. Moreover, a low-k dielectric layer which has undergone metal CMP, for example, Cu CMP, is well-suited for being cleaned by the method according to the present invention.

The HF solution used in the present invention has an HF concentration of 0.06-0.7% by weight. Preferably, the anode water and the HF solution are supplied simultaneously during an initial stage for a predetermined time period. The supplying of the HF solution is then cut off and remains so during a final stage in which the cleaning process is completed using only the anode water. Preferably, the initial stage is performed for 5-20 seconds and the final stage is performed for 1-10 minutes. This ensures that all contaminants, such as slurry abrasive, Cu ions, etc., are removed from the wafer without damaging the layer (for example, the low-k dielectric layer) exposed at the surface of the wafer.

In a manner similar to that in which the anode water is used for cleaning as described above, a cleaning-target object is loaded into the second cleaning apparatus 160, and is cleaned by supplying the cathode water through the second outlet line 130 and HF solution through the HF inlet line 200 into the second cleaning apparatus 160. As was the case with the anode water, the cathode water and the HF solution are preferably supplied at the same time during an initial stage for a predetermined time period, and then only the cathode water is supplied (during the final stage).

Note, however, when the cleaning-target object is a wafer on which a low-k dielectric layer is exposed, the anode water should be used considering its pH and ORP.

The same electrolyte can be used in the system of FIG. 2B to produce cathode water and anode water. In this case, after a cleaning-target object is loaded into the cleaning apparatus 170, anode water and HF solution are supplied at the same time into the cleaning apparatus 170 through the first outlet line 120 and the HF inlet line 200, respectively. This initial stage of the cleaning process is performed for a predetermined period, preferably, for 5-20 seconds. Subsequently, the supply of the HF solution is cut off and only the anode water is supplied for 1-10 minutes. Finally, cathode water is supplied into the cleaning apparatus 170 to complete the cleaning process. The alternating supplying of anode water and cathode water may be repeated if necessary to unsure a complete cleaning of the cleaning-target object. Also, note, when anode water and cathode water are sequentially supplied onto a surface of a cleaning-target object, a passivation layer can be formed on the surface due to surface charge control effects. In this case, a rinsing process following the cleaning process can be omitted.

In a second preferred embodiment of the cleaning method according to the present invention, the intermediate cell 50 is filled with 3-15% by weight ammonium hydroxide aqueous solution, and electrolysis is carried out under the same conditions as described in connection with the first embodiment.

The electrolyte supplied into the intermediate cell 50 is dissociated into anions (OH⁻) and cations (NH₄⁺). The anions migrate into the anode cell 30, and the cations migrate into the cathode cell 40. The reactions in the cells 30 and 40 are expressed as follows.

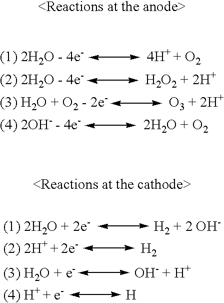

As is clear from the reaction schemes set out above, major components of the anode water produced in the anode cell 30 include oxidative substances, such as H⁺, O₂, and O₃, whereas major components of the cathode water produced in the cathode cell 40 include reductive substances, such as NH₄⁺, OH⁻, H₂, and H^{.}.

The anode water containing these oxidative substances has a pH of 7-9 and an ORP of +100 mV or greater, preferably +100˜+600 mV. The cathode water containing the reductive substances has a pH of 9 or greater and an ORP of −500 mV or less.

The cleaning-target object is cleaned using electrolytic ionized water produced through the electrolysis and HF solution of 0.06-0.7% HF by weight at the same time. Anode water is, though, preferable for use along with the HF solution, considering its pH and ORP.

In a third preferred embodiment of the cleaning method according to the present invention, the intermediate cell 50 is filled with an aqueous solution of 3-15% by weight hydrochloric acid, and electrolysis is carried out under the same conditions as described in connection with the first embodiment.

The electrolyte supplied into the intermediate cell 50 is dissociated into anions (Cl⁻) and cations (H⁺), and the anions migrate into the anode cell 30, and the cations migrate into the cathode cell 40. The reactions in the cells 30 and 40 are as follows.

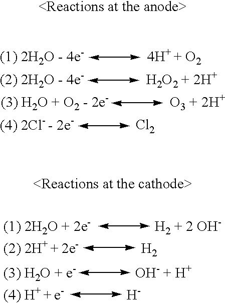

As is clear from the reaction schemes set out above, major components of the anode water produced in the anode cell 30 include oxidative substances, such as H⁺, O₂, and O₃, whereas major components of the cathode water produced in the cathode cell 40 include reductive substances, such as OH⁻, H^{.}, and H₂.

The anode water containing these oxidative substances has a pH of 4 or less, preferably a pH of 2˜4, and an ORP of +700 mV or greater, preferably +700˜+1000 mV. The cathode water containing the reductive substances has a pH of 3-5 and an ORP of −100 mV or less.

The cleaning-target object is cleaned using electrolytic ionized water produced through the electrolysis and HF solution of 0.06-0.7% HF by weight at the same time. Again, though, the anode water is preferable for use along with the diluted HF solution, considering its pH and ORP.

The following examples are illustrative of the efficacy of the present invention. However, these examples are for illustrative purposes only and are not intended to limit the scope of the invention.

### EXPERIMENTAL EXAMPLE 1

### Evaluation of Damage of Low-k Dielectric Layer

Fluorosilicate glass was deposited on a wafer to a thickness of 5000 Å, and a plurality of trenches (0.8 μm) were formed in the fluorosilicate glass layer. A tantalum nitride layer was formed on the inner wall of the glass layer defining the trenches as a barrier metal layer, and the trenches were filled with a copper layer by electroplating. The copper layer was then polished by CMP.

The wafer was then cleaned in the system of FIG. 2A. Deionized water was supplied into the cathode cell 30 and the anode cell 40 at a flow rate of 1 L/min. After the intermediate cell 50 was filled with 13% by weight ammonium hydroxide aqueous solution and 2% by weight HF solution, DC power was applied to the anode 60 and the cathode 70 to produce a current of 10A. Accordingly, electrolysis occurred. The wafer was cleaned using anode water produced through the electrolysis and the HF solution (0.2% by weight). In the cleaning process, the anode water and the diluted HF solution were supplied at the same time through the respective inlet lines for 10 seconds, the supply of the HF solution was then cut off, and then the supplying of the anode water was continued for about 60 seconds. Another wafer that also had undergone Cu-CMP was cleaned with just the HF solution (0.2% HF by weight) according to the conventional method.

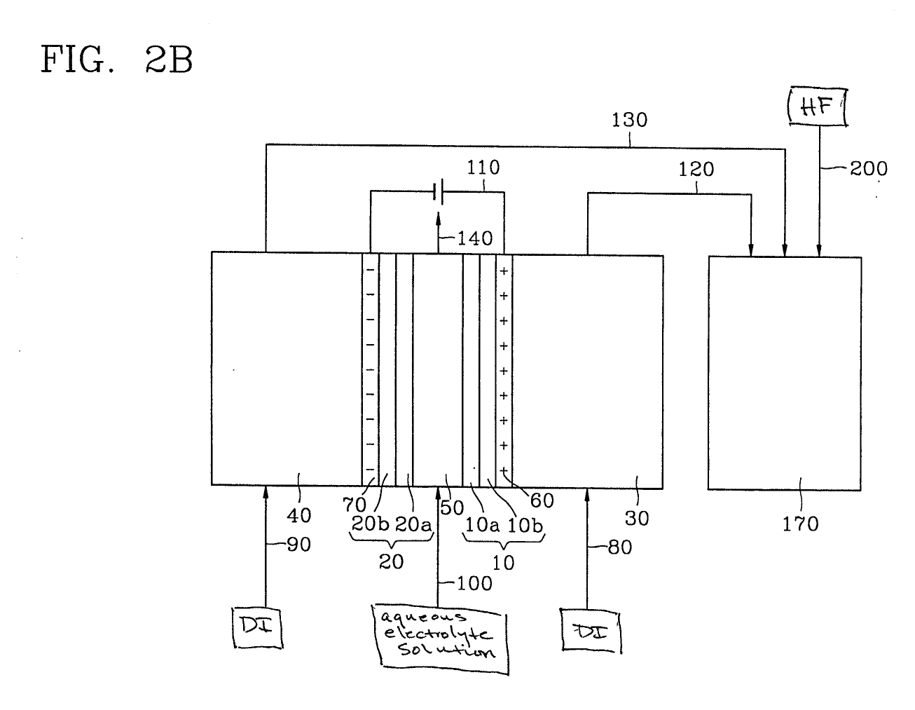

The image of the cleaned surface of the wafer from a scanning electron microscope (SEM) photograph is schematically shown in FIG. 3. In this case, the fluorosilicate glass layer 3′ of the wafer was etched at least 150 Å less during the cleaning process according to the present invention than was the fluorosilicate glass layer of a nearly identical wafer cleaned using the conventional method.

### EXPERIMENTAL EXAMPLE 2

### Evaluation of Particle Removal Capability

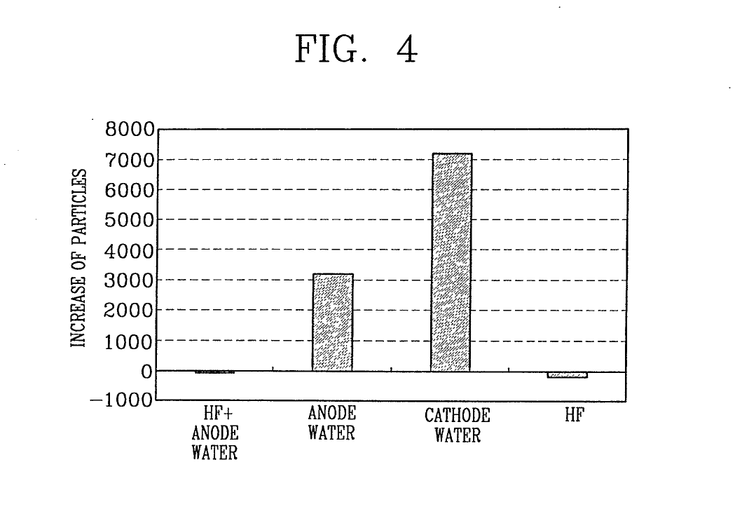

Four wafers each having a 6000 Å-thick silicon oxide layer were prepared. Next, the number of particles present on the surface of each of the wafers was counted using a counter (a SurfScan 6420, manufactured by Tencor Co.). The semiconductor wafers were touched with, rather than fully polished, with a Cu-CMP slurry, to prepare the samples. Electrolytic ionized water was produced in the same manner as in Experimental Example 1 using 13% by weight ammonium hydroxide aqueous solution and 2% by weight HF solution as electrolytes. One of the samples was cleaned simultaneously using anode water and 0.2% by weight HF solution as in Experimental Example 1. The remaining three samples were cleaned using anode water, cathode water, and the conventional HF solution, respectively, for 60 seconds. Then, the particles on the respective wafers were counted, and these numbers were compared with the number of particles counted before the wafers were touched with Cu-CMP slurry. The results are shown in FIG. 4. As shown in FIG. 4, the ability of the cleaning method according to the present invention to remove particle residue is excellent (exhibiting a particle increase of less than −50). It is thus apparent that the ability of the cleaning method according to the present invention to remove particle residue is almost the same as that of the conventional method which exclusively uses an HF solution.

### EXPERIMENTAL EXAMPLE 3

### Evaluation of Copper Removal Capability

Four wafers that had underdone Cu-CMP were prepared in the same manner as in Experimental Example 1.

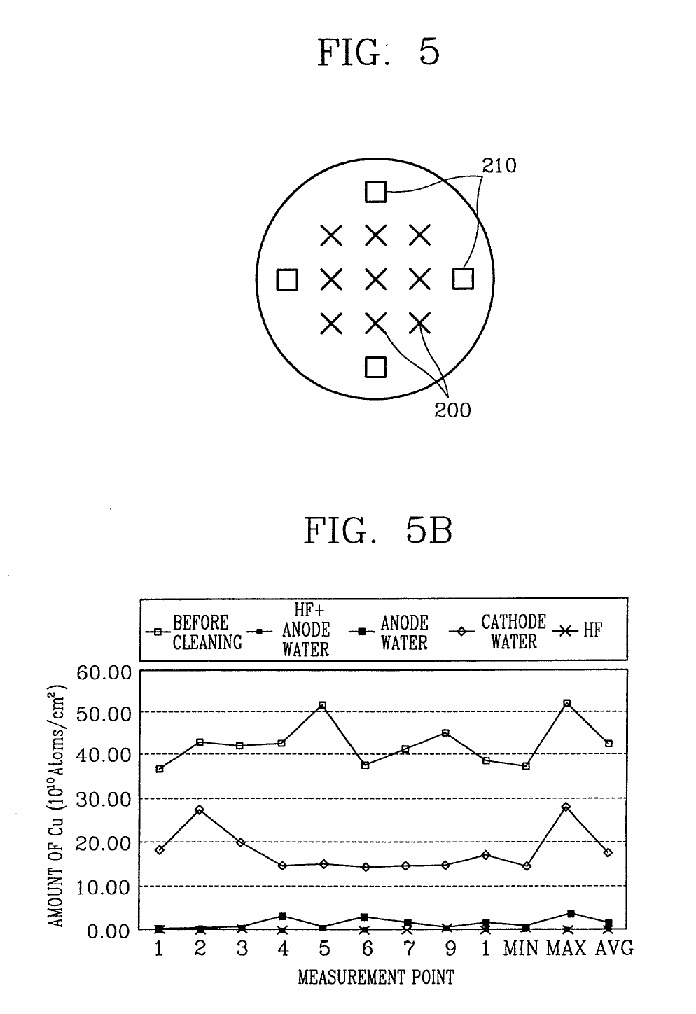

The amount of Cu remaining on the respective wafers was measured at nine points designated by reference numeral 200 in FIG. 5A using a total reflection X-ray fluorescence (TXRT) apparatus. In FIG. 5A, reference numeral 210 denotes individual chips.

The four wafers were cleaned by the four different methods, respectively, as in Experimental Example 2. Then, the amount of remaining copper was measured. The results are shown in FIG. 5B. As is indicated in FIG. 5B, the amount of copper was reduced to 1.0×10¹⁰ Atoms/cm² by the cleaning method according to the present invention, in which the wafer was cleaned simultaneously using anode water and 0.2% by weight HF solution. This method thus exhibits similar Cu removal effects as the conventional method that exclusively uses the HF solution.

Finally, although the present invention has been described above in connection with the preferred embodiments thereof, the invention may, however, be embodied in many different forms without departing from the true spirit and scope thereof as defined by the appended claims.

What is claimed is:

1. A method of cleaning a semiconductor wafer, comprising steps of:
providing an electrolyzer that includes an anode, a cathode, an intermediate cell located between the anode and the cathode, at least one ionizing cell disposed adjacent the intermediate cell and containing a respective one of said anode and said cathode, and a respective ion exchange membrane partitioning each said at least one ionizing cell from the intermediate cell;
supplying deionized water into the at least one ionizing cell of the electrolyzer;
performing electrolysis of an electrolytic aqueous solution in the intermediate cell while the deionized water is in said at least one ionizing cell, to produce electrolytically ionized water in the at least one ionizing cell; and
supplying the ionized water and a sloution of diluted hydrofluoric acid (HF) at the same time onto the surface of the semiconductor wafer.

2. The cleaning method of claim 1, wherein the ionized water and hydrofluoric acid (HF) solution are supplied at the same time onto the surface of a semiconductor wafer having an exposed low-k dielectric layer whose dielectric constant is smaller than that of silicon dioxide.

3. The cleaning method of claim 2, wherein the dielectric layer is formed of a material selected from the group consisting of hydrogen silsequioxane, fluorosilicate glass, polyimide, benzocyclobutene (BCB), Silk (Silicon insulator Low-k), hybrid organic siloxane polymer, and xerogel.

4. The cleaning method of claim 1, wherein the hydrofluoric acid solution contains 0.06-0.7% by weight hydrofluoric acid.

5. The cleaning method of claim 1, wherein the ionized water and the hydrofluoric acid solution are simultaneously supplied onto the surface of the semiconductor wafer during an initial stage of cleaning, and further comprising subsequently supplying only the ionized water onto the surface of the semiconductor wafer during a final stage of cleaning.

6. The cleaning method of claim 1, wherein the at least one ionizing cell comprises an anode cell containing the anode and a cathode cell containing the cathode, and said electrolysis produces anode water, containing oxidative substances, in the anode cell and cathode water, containing reductive substances, in the cathode cell.

7. The cleaning method of claim 6, wherein the anode water and the hydrofluoric acid solution are simultaneously supplied onto the surface of the semiconductor wafer during an initial stage of cleaning, and further comprising subsequently supplying the anode water and the cathode water sequentially onto the surface of the semiconductor wafer during a final stage of cleaning.

8. The cleaning method of claim 7, wherein the anode water and the cathode water are sequentially supplied several times onto the surface of the semiconductor wafer during the final stage of cleaning.

9. The cleaning method of claim 1, wherein the electrolytic aqueous solution is an aqueous solution of 1-15% by weight ammonium hydroxide and 1-15% by weight fluoride.

10. The cleaning method of claim 9, wherein the fluoride is one of hydrogen fluoride and ammonium fluoride.

11. The cleaning method of claim 9, wherein the ionized water contains oxidative substances and has a pH of 2˜6 and an oxidation-reduction potential (ORP) of +300˜+1000 mV.

12. The cleaning method of claim 1, wherein the electrolytic aqueous solution is an aqueous solution of 3-15% by weight ammonium hydroxide.

13. The cleaning method of claim 12, wherein the ionized water contains oxidative substances and has a pH of 7˜9 and an oxidation-reduction potential (ORP) of +100˜+1000 mV.

14. The cleaning method of claim 1, wherein the electrolytic aqueous solution is an aqueous solution of 3-5% by weight hydrochloric acid.

15. The cleaning method of claim 14, wherein the ionized water contains oxidative substances and has a pH of 2˜4 and an oxidation-reduction potential (ORP) of +700˜+1000 mV.

16. A method of processing a semiconductor wafer in the manufacturing of a semiconductor device, comprising steps of :
performing a chemical mechanical polishing process on a semiconductor wafer having a metal layer on a low-k dielectric layer, whose dielectric constant is smaller than that of silicon dioxide, wherein the dielectric layer is exposed and impurities as the result of the process are produced on the surface of the semiconductor wafer; and
subsequently cleaning the surface of the semiconductor wafer, to remove the impurities produced by the chemical mechanical polishing process, by simultaneously supplying electrolytic ionized water and a solution of diluted hydrofluoric acid (HF) onto the polished surface of the wafer.

17. The processing method of claim 16, wherein the metal layer comprises copper.

18. The processing method of claim 16, wherein said cleaning of the surface of the semiconductor wafer comprises producing the ionized water by
providing an electrolyzer having a cathode, an anode, an intermediate cell located between the cathode and the anode, at least one ionizing cell adjacent the intermediate cell and containing a respective one of said anode and said cathode, and at least one ion exchange membrane partitioning said at least one ionizing cell from the intermediate cell,
supplying deionized water into the at least one ionizing cell of the electrolyzer, and
performing electrolysis of an electrolytic aqueous solution in the intermediate cell while the deionized water is in the at least one ionizing cell.

19. The processing method of claim 16, wherein said cleaning the surface of the semiconductor wafer comprises supplying the ionized water and the hydrofluoric acid solution simultaneously onto the surface of the semiconductor wafer during an initial stage of said cleaning, and subsequently supplying only the ionized water onto the surface of the semiconductor wafer during a final stage of said cleaning.

20. The processing method of claim 16, wherein the at least one ionizing cell comprises an anode cell in which the anode is disposed and a cathode cell in which the cathode is disposed, said supplying of deionized water comprises supplying deionized water into the anode cell and the cathode cell, and said electrolysis produces anode water, containing oxidative substances, in the anode cell and cathode water, containing reductive substances, in the cathode cell.

21. The processing method of claim 20, wherein said cleaning the surface of the semiconductor wafer comprises supplying the anode water and the hydrofluoric acid solution simultaneously onto the surface of the semiconductor wafer during an initial stage of said cleaning, and subsequently supplying the anode water and the cathode water sequentially onto the surface of the semiconductor wafer during a final stage of said cleaning.

22. The processing method of claim 21, wherein the anode water and the cathode water are sequentially supplied several times onto the surface of the semiconductor wafer during the final stage of cleaning.

23. The processing method of claim 20, wherein the electrolytic aqueous solution is an aqueous solution of 1-15% by weight ammonium hydroxide and 1-15% by weight fluoride.

24. The processing method of claim 20, wherein the electrolytic aqueous solution is an aqueous solution of 3-15% by weight ammonium hydroxide.

25. The processing method of claim 20, wherein the electrolytic aqueous solution is an aqueous solution of 3-5% by weight hydrochloric acid.

26. A cleaning system for use in cleaning the surface of a semiconductor wafer, said cleaning system comprising:
a 3-cell electrolyzer including an anode cell containing an anode, a cathode cell containing a cathode, an intermediate cell interposed between said anode cell and said cathode cell, and ion exchange membranes partitioning said intermediate cell from said anode cell and said cathode cell, respectively;
at least one semiconductor wafer cleaning apparatus for use in cleaning semiconductor wafers;
a source of a solution of diluted hydrofluoric acid, and at least one HF solution inlet line connecting said source of the solution of diluted hydrofluoric acid to said at least one semiconductor wafer cleaning apparatus; and
ionized water oulet lines connecting said anode cell and said cathode cell to said at least one semiconductor wafer cleaning apparatus, whereby the hydrofluoric acid solution and electrolytically ionized water from said 3-cell electrolyzer can be supplied to said at least one semiconductor wafer cleaning apparatus.

27. The cleaning system of claim 26, wherein said at least one semiconductor wafer cleaning apparatus comprises a pair of discrete semiconductor wafer cleaning apparatuses, and said ionized water oulet lines connect said anode cell and said cathode cell to said semiconductor wafer cleaning apparatuses, respectively.

28. The cleaning system of claim 26, wherein said ionized water outlet lines connect said anode cell and said cathode cell to the same said semiconductor wafer cleaning apparatus.

29. The cleaning system of claim 26, and further comprising a source of deionized water, and deionized water inlet lines connecting said source of deionized water to said anode cell and said cathode cell.

30. The cleaning system of claim 26, and further comprising a source of an aqueous electrolytic solution, an electrolytic solution inlet line connecting said source of an aqueous electrolytic solution to said intermediate cell, and a drain extending from said intermediate cell.

31. The cleaning system of claim 26, wherein the electrolytic aqueous solution is an aqueous solution of 1-15% by weight ammonium hydroxide and 1-15% by weight fluoride.

32. The cleaning system of claim 26, wherein the electrolytic aqueous solution is an aqueous solution of 3-15% by weight ammonium hydroxide.

33. The cleaning system of claim 26, wherein the electrolytic aqueous solution is an aqueous solution of 3-5% by weight hydrochloric acid.

34. The cleaning system of claim 26, wherein said ion exchange membranes comprise, between said anode cell and said intermediate cell, a fluorine-based cationic exchange membrane adjacent said anode cell and an anionic exchange membrane adjacent said intermediate cell.

35. The cleaning system of claim 26, wherein said ion exchange membranes comprise, between said cathode cell and said intermediate cell, an anionic exchange membrane adjacent said cathode cell and an cationic exchange membrane adjacent said intermediate cell.

36. The cleaning system of claim 26, wherein a DC power source is connected to said anode and cathode.
